(19) United States
(12) Patent Application Publication
(10) Pub. No.: US 2014/0279609 A1
(43) Pub. Date: Sep. 18, 2014

(54) Systems and methods for managing conditional curtailment options

(71) Applicant: Open Access Technology International, Inc., Minneapolis, MN (US)

(72) Inventors: Khashayar Nodehi Fard Haghighi, Maple Grove, MN (US); Paul Raymond Sorenson, Tega Cay, SC (US); Sasan Mokhtari, Eden Prairie, MN (US); Steven Allen Glaim, Minneapolis, MN (US); Kevin John Sarkinen, Greenfield, MN (US)

(73) Assignee: Open Access Technology International, Inc., Minneapolis, MN (US)

(21) Appl. No.: 14/216,179

(22) Filed: Mar. 17, 2014

Related U.S. Application Data
(60) Provisional application No. 61/791,423, filed on Mar. 15, 2013.

(51) Int. Cl. G06Q 30/00

(52) U.S. Cl. CPC G06Q 30/018
USPC 705/317

(57) ABSTRACT

Systems and methods for producing recommended Transmission Service Reservation (TSR) actions whereby a Criteria Monitoring Process and Tag Identification and Action Process uses CCO Criteria, Capacity, Curtailment Interval, Model Elements Monitor, Tag Transactions, and Capacity Computation results to produce Recommended TSR Actions and Recommended Tag Actions based upon existing Conditional Curtailment Options on TSRs. Additional systems and methods disclosed further include the previous systems and methods with the additional ability to take action of the Recommended TSR Actions and Recommended Tag Actions.

### CROSS-REFERENCE TO RELATED APPLICATIONS

This application claims priority to U.S. Provisional patent application No. 61/791,423 filed Mar. 15, 2013, the entire content of which is hereby incorporated by reference.

Applicant has other co-pending applications directed to the energy market, namely:

SYSTEMS AND METHODS FOR DEMAND RESPONSE AND DISTRIBUTED ENERGY RESOURCE MANAGEMENT, filed Feb. 9, 2011 and assigned application Ser. No. 13/024,158, the entire contents of which is hereby incorporated by reference.

AUTOMATION OF ENERGY TRADING, filed Dec. 30, 2011 and assigned application Ser. No. 13/140,248, the entire contents of which is hereby incorporated by reference.

CERTIFICATE INSTALLATION AND DELIVERY PROCESS, FOUR FACTOR AUTHENTICATION, AND APPLICATIONS UTILIZING SAME, filed Oct. 15, 2013 and assigned application Ser. No. 14/054,611, the entire contents of which is hereby incorporated by reference.

A renewable energy credit management system and method, filed Feb. 10, 2014 and assigned application Ser. No. 14/176,590, the entire contents of which is hereby incorporated by reference.

Systems and methods of determining optimal scheduling and dispatch of power resources, filed on Mar. 17, 2014 (Docket No. O17.2P-15315-US03), the entire contents of which is hereby incorporated by reference.

Systems and methods for managing energy generation and procurement, filed on Mar. 17, 2014 (Docket No. O17.2P-15469-US03), the entire contents of which is hereby incorporated by reference.

Systems and methods for tracing electrical energy of a load to a specific generator on a power grid, filed on Mar. 17, 2014 (Docket No. O17.2P-15493-US03), the entire contents of which is hereby incorporated by reference.

Systems and methods for trading electrical power, filed on Mar. 17, 2014 (Docket No. O17.2P-15565-US03), the entire contents of which is hereby incorporated by reference.

Systems and methods for tracking greenhouse gas emissions, filed on Mar. 17, 2014 (Docket No. O17.2P-15954-US02), the entire contents of which is hereby incorporated by reference.

Systems and methods for parameter estimation for use in determining value-at-risk, filed on Mar. 17, 2014 (Docket No. O17.2P-15955-US02), the entire contents of which is hereby incorporated by reference.

Systems and methods for managing transmission service reservations, filed on Mar. 17, 2014 (Docket No. O17.2P-15956-US02), the entire contents of which is hereby incorporated by reference.

Systems and methods for interfacing an electrical energy end user with a utility, filed on Mar. 17, 2014 (Docket No. O17.2P-15958-US02), the entire contents of which is hereby incorporated by reference.

Use of Demand Response (DR) and Distributed Energy Resources (DER) to mitigate the impact of Variable Energy Resources (VER) in Power System Operation, filed on Mar. 17, 2014 (Docket No. O17.2P-15959-US02), the entire contents of which is hereby incorporated by reference.

### FIELD OF THE INVENTION

The present invention relates to the creation, monitoring, management, and execution of Transmission Service Reservations and Tags. Specifically in relation to Conditional Curtailment Option terms on long Term Transmission Service Reservations. These activities are typically aimed at the administration of an Open Access Transmission Tariff.

### BACKGROUND OF THE INVENTION

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

The FERC Order 890 and NAESB Standards adopted under FERC Order 676-E establish requirements to implement the handling of Long-term Firm Point-to-Point Transmission Service Agreements executed subject to a Conditional Curtailment Option (CCO), also referred to as Conditional Firm service. The invention disclosed pertains to the creation, monitoring, and execution actions related to CCOs. The invention monitors each CCO and produces Recommended Transmission Service Reservation (TSRs) Actions and Recommended Tag Actions in real time according to the details of each CCO.

Transmission Customers seeking long-term firm transmission service arrangements were often denied such service when specific system conditions may be present for only certain periods of time for which transmission service is sought. Transmission Provider's would deny such requests in their entirety because it was not feasible to provide firm transmission service for each and every time period over the term requested. The CCO was a means that the Transmission Provider could communicate to the Transmission Customer that there was a risk of curtailment of transmission service under certain conditions or time periods, and the Transmission Customer could accept that risk to receive long-term transmission service with the stipulation that during those conditions or time periods the transmission service priority for curtailment would be reduced below that of firm service. The terms to be applied to transmission service granted subject to CCO must be incorporated into the long-term service agreement and filed with the FERC.

Due to the plurality of elements on each TSR with a Condition Curtailment Option and the large plurality of TSRs with CCOs, the Electricity Transmission Industry requires a systematic method of monitoring, analyzing, and acting in response to CCO terms. The invention disclosed is able to monitor a large plurality of CCOs and produce Recommended TSR Actions and Recommended Tag Actions in real-time through the invention's processes.

### BRIEF SUMMARY OF THE INVENTION

In at least one embodiment, the invention is directed to a computer program for use with a graphics display device, the computer program comprising a computer usable medium having computer readable program code means embodied in the medium the creation, monitoring, managing, and execution of actions related to terms of transmission service reservations with Conditional Curtailment Option terms.

The main embodiment of the invention (FIG. 1.) uses Conditional Curtailment Criteria, Request Capacity, the Curtailment Interval, and a Physical Model to produce Recommended TSR Actions and Recommended Tag Actions. These Actions are produced by a Criteria Monitoring Process and a Tag Identification and Action Process with access to Capacity Computation Results. Recommended TSR and Recommended Tag actions are actions that need to be taken in order to properly execute the conditions detailed in the CCO specified on the TSR.

Another embodiment of the invention (FIG. 2.) is able to send Recommended TSR Actions and Recommended Tag Actions to a Congestion Management System allowing the Congestion Management System to take the appropriate TSR Actions and Tag Actions. Yet another embodiment of the invention (FIG. 3.) is able to act on the Recommended TSR Actions and Recommended Tag Actions and take the appropriate TSR Actions and Tag Actions.

### BRIEF DESCRIPTION OF THE SEVERAL VIEWS OF THE DRAWINGS

The present invention will be explained in more detail below by means of drawings.

FIG. 1 is a block diagram illustrating the data flows through an embodiment of the invention.

FIG. 2 is a block diagram illustrating the data flows through an embodiment of the invention where the sends Recommended TSR Actions and Recommended Tag Actions to a Congestion Management System.

FIG. 3 is a block diagram illustrating the data flows through and embodiment of the invention where the invention is able to act on Recommended TSR Actions and Recommended Tag Actions.

FIG. 4 is a block diagram illustrating a computer system that may be utilized in the performance of the disclosed methods and processes.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

The FERC Order 890 and NAESB Standards adopted under FERC Order 676-E establish requirements to be implemented in the handling of Long-term Firm Point-to-Point Transmission Service Agreements that are executed subject to a CCO also referred to as Conditional Firm service. The invention disclosed pertains to the creation, monitoring, and execution of actions related to Transmission Service Reservations (TSRs) with CCOs. The invention disclosed is a method of producing Recommended TSR Actions 109 and Recommended Tag Actions 110. Recommended TSR Actions 109 and Recommended Tag Actions 110 are the actions that need to be taken in order to properly execute the conditions detailed in the CCO terms detailed on the TSR. TSR Actions 111 and Tag Actions 112, found in some embodiments, are the changes to the TSRs and Tags detailed in Recommended TSR Actions 109 and Recommended Tag Actions 110.

Generally, an embodiment of the invention (FIG. 1.) is combined with, or maintained within, a Congestion Management System 105. A Congestion Management System 105 is a system utilized for the purpose of managing the creation of, approval of, tracking of, and billing for TSRs or Tags. Often a Congestion Management System 105 utilizes a mathematical model (Data Model) of a physical electrical grid for these purposes. This Data Model is often called the Physical Model because its purpose is to describe the physical movement of electricity across grid.

A User of the invention hereinafter is any person affiliated with the administration and maintenance of the Congestion Management System 105. Whereas a requestor is a party submitting TSR or Tag requests to the Congestion Management System 105.

A Congestion Management System assumes the responsibility for monitoring of all transactional uses of the physical electrical grid to ensure that such use will not exceed component ratings or limits. When violations of component rating or limits are anticipated the Congestion Management System may invoke a curtailment management procedure whereby those transactions that are contributing to the limit violation are forced to reduce their impact on the overloaded facilities. The relative priorities for use of the physical electrical grid are associated with the class of transmission service reserved and paid for by the Transmission Customer. Higher priority service uses of the transmission system are preserved, while lower priority services are required to reduce their use of the transmission system, i.e., curtailed, to mitigate the limit violations experienced. With respect to service provided with a CCO provision, the priority of service may be on par with all other firm uses of the transmission system when limit violations are not anticipated, but then reduced and subject to curtailment before all other firm uses of the transmission system when limit violations are more likely to be encountered.

Provisions associated with CCOs vary. Examples of possible conditions include:
Long-term Firm Point-to-Point service subject to CCO will be based on the results of a System Impact Study conducted by the Transmission Provider.
Requests for Long-term Firm Point-to-Point service may be granted subject to CCO. If granted, the following provisions will apply:
A fixed MW portion of the requested capacity may be granted and treated as firm, NERC priority 7, service.
The balance of the requested capacity will be granted and treated on-par with Network service from non-designated resources, NERC priority 6, based on either an ‘HOURS’ or ‘SYSTEM CONDITIONS’ criteria.
Curtailment of service subject to CCO will be treated on-par (e.g., pro-rata vs. LIFO) with all other services granted at the same curtailment priority.
The service granted may be subject to biennial reassessment.
In the event Short-term Firm ATC becomes available, that portion of service granted subject to curtailment at priority 6 will be made firm and curtailed pro-rata at priority 7.

Inputs to an embodiment of the invention may include but are not limited to: a set of CCO Criteria 100, a Capacity Value 101, a Curtailment Interval 102, a Model Element to Monitor 103, and Tags Transactions 104. Often the CCO Criteria 100, Capacity 101, Curtailment Interval 102, Model Element to Monitor 103 enter the Congestion Management System 105 via a TSR. In one embodiment of the invention these inputs may be used by a Criteria Monitoring Process 106 and a Tag Identification Process 108 to produce the inventions outputs. The Criteria Monitoring Process and 106 and Tag Identification Process 108 utilize Capacity Computation Results 106 often typically stored within, generated within, or sent to the Congestion Management System 105. Typical outputs of an embodiment may include Recommended TSR Actions 109 and Recommended Tag Actions 110. A typical Recommended TSR Action 109 is the adjustment of the priority value of the TSR or the adjustment of a transmission limit stored within the TSR. A typical Recommended Tag Action 110 is the adjustment of the Tag's priority value or limit to match its corresponding TSR. Another embodiment of the invention (FIG. 2.) is able to send Recommended TSR Actions 109 and Recommended Tag Actions 110 to a Congestion Management System 105 allowing the Congestion Management System 105 to take the appropriate TSR Actions 111 and Tag Actions 112. Yet another embodiment of the invention (FIG. 3.) is able to act on the Recommended TSR Actions 109 and Recommended Tag Actions 110 and take the appropriate TSR Actions 111 and Tag Actions 112 itself.

CCO Criteria 100 may be used to define characteristics associated with the management of transmission services subject to CCO. These may include but are not limited to: criteria used to record a set of enumerated values to be used to identify the nature of the CCO; criteria establishing the default value to be applied for the CCO; criteria enabling the ability of user to manually enter an amount of capacity subject to CCO at less than the full capacity of the TSR; criteria recording a relative time that a given set of CCO conditions will remain in effect; a criteria recording a relative time period prior to expiration of current CCO conditions when notification of the need for reassessment will be issued to the user; and a criteria recording a relative time between successive notifications of need for reassessment will be issued to the TP. CCO Criteria 100 are used by the Criteria Monitoring Process 107 to determine the method of monitoring needed for each CCO.

A Capacity 101 value indicates the amount of transmission capacity subject to the provisions of the CCO. This value may be the full or partial value of the TSR.

A Curtailment Interval 102 value is used to establish an accounting time period. This time period may be used by the invention to set an interval of time over which a criterion is monitored or an event counted.

A Model Element 103 or Model Elements 103 are used to determine what corresponding elements of the physical model the request is associated with. The Criteria Monitoring Process 107 will use the Capacity Computation Results 106 to monitor the element or elements in its monitoring process.

Capacity Computation Results 106 are the capacity values on each element in the physical model of electrical grid the TRS containing CCOs are used to reserve transmission on. These results are often generated or stored within a Congestion Management System 105. In some embodiments the Capacity Computation Results may be sent directly to the invention. In some embodiments the invention may have access to the results for its use in the Criteria Monitoring Process 107.

The Criteria Monitoring Process 107 will select a method of monitoring using the CCO Criteria 100. One embodiment of the invention will use either an On Event monitoring method or an Always monitoring method.

If the CCO Criteria 100 indicate to apply the reduction in curtailment priority On Event, the process will monitor for any time periods when the specified event as defined in the CCO Criteria 100 by the user is in effect and Recommend TSR Action to reduce the capacity subject to the CCO to a lower priority for the duration of the event. Events triggering this may include but are not limited to: specific transmission facility outages, higher than anticipated load requirements, generator outages. These events are typically recorded within the Congestion Management System 105 and are accessible by the Criteria Monitoring Process 107. In some embodiments they may be sent directly to the Criteria Monitoring Process 107 from outside the Congestion Management System 105. If the time interval of specified event is updated, corresponding recommendations will be made to the curtailment priority of the capacity subject to CCO. The ‘On Event’ option may be applied to service subject to the ‘hours’ CCO Criteria 100 allowing the user to control when the service is to be treated as firm versus at its reduced priority. In this case, the user would declare the specified event as in effect anytime the service curtailment priority is to be reduced and clear or cancel that event to restore service to a higher priority value.

If the CCO Criteria 100 indicated that the Always method should be used, the CCO will be treated as firm service and given a priority value (typically priority 6) according to that service in the Congestion Management System 105 and the full amount reserved and for the entire term of the reservation until such time that the maximum number of curtailment hours has been reached over an established period of time. The maximum number of curtailment hours that may be incurred by the Transmission Customer over an established interval in time is specified as part of the CCO long-term service agreement. This maximum number may be included or sent to the invention as CCO Criteria 100 or provided by the Congestion Management System 105. The Criteria Monitoring Process 107 will monitor for all curtailments issued to transaction tags that are subject to CCO and maintain a running count of the number of hours the Transmission Customer's service was forced to be reduced at the lowered CCO priority. Should the maximum number of curtailment hours be exceeded over the applicable term of that maximum number of hours, the CCO service will be restored to firm service priority level for the balance of that applicable term.

For both the ‘on-event’ and ‘always’ methods, there is a further requirement that all service subject to CCO must be restored to the firm service priority level prior to offering any short-term firm service to other Transmission Customers. The Criteria Monitoring Process 107 will monitor the firm capacity on each identified model element of the physical model. The Criteria Monitoring Process 107 will use the Capacity Computation Results 106 for this monitoring. If at any time the firm capacity is determined to be greater than or equal to zero (0), or other user defined threshold limit detailed by a CCO Criteria 100, on all elements associated with a given CCO reservation, that CCO reservation will receive a recommendation to be restored to its firm priority value in full. While the Firm ATC/AFC provided by the Capacity Computation Results 106 may fluctuate at a negative value due to adjustments, the firm capacity becoming positive indicates that all CCO services granted may be accommodated in full at a Firm priority in addition to the possibility for further short-term sales to be made. Once a recommendation to raise the priority value over an interval in time, the service reserved will not be subject to curtailment at a reduced priority value even if subsequent recalculation of firm capacity results in a value less than zero (0). The priority value of the CCO TSR will not be lowered until all of the capacity on all of the monitored elements impacted by this CCO TSR become available in the short-term simultaneously for that period of time when the constraints no longer exist. No short-term service will be made available until the capacity on the impacted monitored elements become positive taking into account that the negative value on the impacted flowgates accounts.

The Criteria Monitoring Process 107 will monitor all reservations subject to a CCO provision for the current operating curtailment priority over time. As new tagged transactions are moved to a confirmed/implemented status based on all approval entities approving the transaction, Criteria Monitoring Process 107 will determine if any portion of the reserved capacity allocated over time in support of the transaction is operating at a reduced curtailment priority, and if so, will issue a recommendation to adjust the tag's transmission allocation profile to reflect that reduced priority. Criteria Monitoring Process 107 will also monitor for any new reductions in curtailment priority due to new declared ‘security events’ bound to any reservations subject to CCO and recommend the appropriate adjustment of the tag's transmission allocation profile to reflect that reduced priority. Similarly, Criteria Monitoring Process will monitor for the release of any reductions in curtailment priority due to revision to declared ‘security events’, detection of available short-term firm ATC, or meeting the maximum curtailment hours criteria for the CCO and issue the appropriate adjustment of the tag's transmission allocation profile to reflect that reinstatement of the firm curtailment priority.

The Tag Identification and Action Process 108 ensures that Tags referencing TSRs with CCOs are receive Recommended Tag Actions 108 in accordance with the Recommended TSR Actions. As new Tag Transactions 104 are moved to a confirmed/implemented status based on all approval entities approving the transaction the Tag Identification and Action Process 108 will reference the corresponding TSRs to the new Tag Transactions 104. If any of the corresponding TSRs are found to have CCOs the Tag Identification and Action Process 108 will continue to monitor the TSRs and produce Recommended Tag Actions 110 in relation to the Recommended Transmission Service Reservations Actions 109 produced by the Criteria Monitoring Process 107.

An embodiment of the invention may be able to act upon the Recommended TSR Actions 109 and Recommended Tag Actions 110. In one embodiment the Congestion Management System may be able to receive Recommended Transmission Service Reservation Actions and Recommended Tag Actions from the invention and take the appropriate TSR Actions and Tag Actions. In another embodiment of the invention (FIG. 3.) the invention may be able to take the appropriate TSR Actions 111 and Tag Actions 112 on the TSRs and Tags itself

Some or all of the previously discussed embodiments may be performed utilizing a computer or computer system. An example of such a computer or computer system is illustrated in FIG. 4. Computer 600 contains Central Processing Unit 601. Central Processing Unit 601 may perform some or all of the processes involved in the previously discussed embodiments. Central Processing Unit 601 may utilize information contained in Memory 602, Database 603, or both. Central Processing Unit 601 may also write information to Memory 602, Database 603, or both. While in this FIG. 5 only one Computer 600 is shown, some embodiments may make use of multiple computers or computer systems. In some embodiments some of these computers or computer systems may not have dedicated memory or databases, and may utilize memory or databases that are external to the computer or computer system.

The above examples and disclosure are intended to be illustrative and not exhaustive. These examples and description will suggest many variations and alternatives to one of ordinary skill in this art. All of these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of written description, any dependent claim which follows should be taken as alternatively written in a multiple dependent form from all claims which possess all antecedents referenced in such dependent claim.

1. A method of managing conditional curtailment options (CCOs), comprising the steps of:
receiving a transmission service reservation (TSR), the TSR including a set of conditional curtailment options, a capacity value for the amount of transmission capacity subject to the CCO, a curtailment interval of time over which the CCO is monitored, and tag transactions;
inputting the TSR to a congestion management system;
monitoring the CCO Criteria using a criteria monitoring process;
processing the TSR with the congestion management system to produce recommended TSR actions;
monitoring TSRs with a tag identification and action process to produce and recommended tag actions based upon recommended TSR actions.

2. The method of claim 1 wherein the recommended TSR action is the adjustment of a priority value of the TSR.

3. The method of claim 1 wherein the recommended TSR action is the adjustment of a transmission limit of the TSR.

4. The method of claim 1 wherein the recommend tag action is the adjustment of a tag's priority value.

5. The method of claim 1 wherein the recommend tag action is the adjustment of a tag's limit to match its corresponding TSR.

6. The method of claim 1 wherein the CCO criteria are one or more of the criteria selected from the group consisting of criteria used to record a set of enumerated values to be used to identify the nature of the CCO, criteria establishing the default value to be applied for the CCO, criteria enabling the ability of user to manually enter an amount of capacity subject to CCO at less than the full capacity of the TSR, criteria recording a relative time that a given set of CCO conditions will remain in effect, criteria recording a relative time period prior to expiration of current CCO conditions when notification of the need for reassessment will be issued to the user, and criteria recording a relative time between successive notifications of need for reassessment will be issued to the TP.

7. The method of claim 1 wherein the TSR further includes an indication of the model element to monitor the corresponding element of the physical model the TSR is associated with.

8. The method of claim 1 further including the step of determining the capacity computation results, which are the capacity values on each element in the physical model of the electrical grid the TSR containing the CCOs used to reserve transmission on.

9. The method of claim 1 in which the recommend TSR actions and recommend tag actions are performed.

10. A system of managing conditional curtailment options (CCOs), comprising:
a computer having a memory and a computer program running in the memory, the computer program being configured to:
receive a transmission service reservation (TSR), the TSR including a set of conditional curtailment options, a capacity value for the amount of transmission capacity subject to the CCO, a curtailment interval of time over which the CCO is monitored, and tag transactions;
input the TSR to a congestion management system;
monitor the CCO Criteria using a criteria monitoring process;
process the TSR with the congestion management system to produce recommended TSR actions;
monitor TSRs with a tag identification and action process to produce and recommended tag actions based upon recommended TSR actions.

11. The system of claim 10 wherein the recommended TSR action is the adjustment of a priority value of the TSR.

12. The system of claim 10 wherein the recommended TSR action is the adjustment of a transmission limit of the TSR.

13. The system of claim 10 wherein the recommend tag action is the adjustment of a tag's priority value.

14. The system of claim 10 wherein the recommend tag action is the adjustment of a tag's limit to match its corresponding TSR.

15. The system of claim 10 wherein the CCO criteria are one or more of the criteria selected from the group consisting of criteria used to record a set of enumerated values to be used to identify the nature of the CCO, criteria establishing the default value to be applied for the CCO, criteria enabling the ability of user to manually enter an amount of capacity subject to CCO at less than the full capacity of the TSR, criteria recording a relative time that a given set of CCO conditions will remain in effect, criteria recording a relative time period prior to expiration of current CCO conditions when notification of the need for reassessment will be issued to the user, and criteria recording a relative time between successive notifications of need for reassessment will be issued to the TP.

16. The system of claim 10 wherein the TSR further includes an indication of the model element to monitor the corresponding element of the physical model the TSR is associated with.

17. The system of claim 10 further including the step of determining the capacity computation results, which are the capacity values on each element in the physical model of the electrical grid the TSR containing the CCOs used to reserve transmission on.

18. The system of claim 10 in which the recommend TSR actions and recommend tag actions are performed.
